(19) United States
(12) Patent Application Publication
(10) Pub. No.: US 2026/0360808 A1
(43) Pub. Date: Nov. 12, 2026

(54) SULFIDE-BASED SOLID ELECTROLYTE AND METHOD FOR PREPARING THE SAME

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Yong Jun Jang, Hwaseong-si (KR); Sang Heon Lee, Hwaseong-si (KR); Dae Yeon Hwang, Hwaseong-si (KR); Yong Gu Kim, Hwaseong-si (KR); Byeong Sun Jun, Hwaseong-si (KR); Jong Soon Kim, Seoul (KR); Tae Gyu Kim, Suwon-si (KR); Jun Seong Kim, Suwon-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 19/645,899

(22) Filed: Apr. 13, 2026

(30) Foreign Application Priority Data
Apr. 30, 2025 (KR) 10-2025-0057593

(51) Int. Cl. H01M 10/0562; H01M 10/0525

(52) U.S. Cl. CPC H01M 10/0562; H01M 10/0525; H01M 2300/008

(57) ABSTRACT

A solid electrolyte including a compound expressed by Li_{a-nb}M_{b}PS_{c}X_{d}, in which ‘M’ is at least one of, or is selected from the group consisting of, transition metal elements having an ion radius ranging from 0.4 Å to 1.0 Å and sulfur association energy of at least 0.5 eV, ‘n’ is an oxidation number of the ‘M’ and greater than 1, ‘X’ is at least one halogen, and 6≤a≤8, 0<b<0.2, 3≤c≤6, 0<d≤3, and 5.2≤a−nb≤6.

### CROSS REFERENCE TO RELATED APPLICATIONS

This application claims the benefit of priority to Korean Patent Application No. 10-2025-0057593, filed in the Korean Intellectual Property Office on Apr. 30, 2025, the entire contents of which are incorporated herein by reference.

### TECHNICAL FIELD

The present disclosure relates to a sulfide-based solid electrolyte and a method for preparing the same, and more particularly, to a sulfide-based solid electrolyte having a specific element substituted at a Li-site.

### BACKGROUND

Recently, as electric, electronic, communication, and computer industries continue to develop and the markets for eco-friendly vehicles and energy storage continue to grow, there becomes an increasing need for lithium secondary batteries which are both extremely safe and low cost. In particular, recent developments in electric vehicles (EV), hybrid electric vehicles (HEV), and plug-in hybrid electric vehicles (PHEV) in combination with increasing energy prices and increased demand for environmental protection is leading to demand for lithium secondary batteries with lower costs and excellent lifetime and capacity characteristics.

As lithium secondary battery use expands, lithium secondary batteries are being developed to have a higher capacity, a lower price, a higher stability, and a larger area. There is also a need for improved safety and performance of the lithium secondary batteries. Conventional lithium secondary batteries employ liquid electrolyte. In such batteries, the risk of leakage and ignition is high, particularly as the batteries' capacity and area continue to increase. Accordingly, recently, to improve safety, studies have been actively performed on fully solid state lithium secondary batteries employing inorganic solid electrolytes which are non-combustible materials. In addition, fully solid state lithium secondary batteries have been spotlighted as next-generation batteries due to safety, higher energy density, and longer lifespans.

In some situations, a fully solid state electrolyte is divided into an oxide-based solid electrolyte and a sulfide-based solid electrolyte, where the sulfide-based solid electrolyte exhibits higher lithium ion conductivity and the stability in a wider voltage range, when compared to the oxide-based solid electrolyte. However, the sulfide-based solid electrolyte may react with moisture in the atmosphere to emit potentially harmful hydrogen sulfide gas (H₂S), and may exhibit inferior oxidation stability at a higher voltage, thereby causing the side reaction with a cathode material during the high-voltage operation. As such, there is a need for an improved fully solid state lithium secondary battery.

### SUMMARY

An aspect of the present disclosure provides a solid electrolyte which exhibits lower reactivity with moisture and excellent ion conductivity.

Another aspect of the present disclosure provides a method for preparing a solid electrolyte which exhibits lower reactivity with moisture in the air, and excellent stability and excellent ion conductivity at a higher voltage.

The technical problems to be solved by the present disclosure are not limited to the aforementioned problems, and any other technical problems not mentioned herein will be clearly understood from the following description by those skilled in the art to which the present disclosure pertains.

In one aspect of the present disclosure, a solid electrolyte includes a compound of Chemical Formula 1:

Li_{a-nb}M_{b}PS_{c}X_{d}, [Chemical Formula 1]

wherein, in Chemical Formula 1, ‘M’ is at least one of, or is selected from the group consisting of, transition metal elements having an ion radius ranging from 0.4 Å to 1.0 Å and sulfur association energy of at least 0.5 eV, ‘n’ is an oxidation number of the ‘M’ and greater than 1, ‘X’ is at least one halogen, and 6≤a≤8, 0<b<0.2, 3≤c≤6, 0<d≤3, and 5.2≤a−nb≤6.

In another aspect of the present disclosure, the solid electrolyte includes a compound of Chemical Formula 2,

Li_{a-nb}□_{nb-b}M_{b}PS_{c}X_{d}, [Chemical Formula 2]

in Chemical Formula 2, ‘M’ is at least one of, or is selected from the group consisting of, Co, Ni, Nb, and Mg, ‘□’ is a vacancy at a Li-site, ‘n’ is an oxidation number of the ‘M’ and is greater than 1, ‘X’ is at least one halogen, and 6≤a≤8, 0<b<0.2, 3≤c≤6, 0<d≤3, 5.2≤a−nb≤6, and 0<nb−b≤2.8.

In another aspect of the present disclosure, the solid electrolyte includes a compound of Chemical Formula 3:

Li_{5.5-nb}□_{nb-b}M_{b}PS_{4.5}Cl_{c1}Br_{c2} [Chemical Formula 3]

wherein, in Chemical Formula 3, ‘M’ is at least one of, or is selected from the group consisting of, Co, Ni, Nb, and Mg, ‘□’ is a vacancy at a Li-site, ‘n’ is an oxidation number of ‘M’ and is greater than 1, 0.05≤b<0.2, 5.235.5-nb≤6, 0<c1≤1, and 0<c2≤1 0<nb−b≤2.8.

In one aspect of the present disclosure, the solid electrolyte has a crystal structure belonging to a space group (F-43m).

In one aspect of the present disclosure, the solid electrolyte has an argyrodite crystal structure.

In one aspect of the present disclosure, in which the solid electrolyte has an a-axis lattice constant that is at most 9.9 Å when calculated through a Rietveld analysis method.

In one aspect of the present disclosure, the solid electrolyte has an L-color value that ranges from 8 to 46 when the solid electrolyte is measured using a Hunter Lab colorimeter.

In one aspect of the present disclosure, a peak is absent at a position in which 2θ is 27±0.5°, 36±0.5°, or 40±1°, in an X-Ray Diffraction (XRD) pattern measured using CuKα with respect to the solid electrolyte.

In one aspect of the present disclosure, a peak is absent at a position in which 20 is 35±0.5°, or 46±0.5°, in an XRD pattern measured using CuKα with respect to the solid electrolyte.

In one aspect of the present disclosure, the solid electrolyte has a resistance, which is calculated through Electrochemical Impedance Spectroscopy (EIS), that is at most 7Ω.

In one aspect of the present disclosure, an ion conductivity of the solid electrolyte is at least 7 mS/cm.

In one aspect of the present disclosure, a peak intensity (P₁) is observed at a position, in which 2θ=25.5±0.5°, in an XRD pattern measured by using CuKα, a peak intensity (P₂) is observed at the position, in which 2θ=25.5±0.5°, in an XRD pattern of the solid electrolyte measured using CuKα, after the solid electrolyte is exposed in a dry room under a dew temperature of −60 °C for 24 hours, and a ratio (P₁:P₂) between the peak intensity (P₁) and the peak intensity (P₂) ranges from 1:0.7 to 1:0.95.

In one aspect of the present disclosure, ion conductivity (I₁) is measured for the solid electrolyte, ion conductivity (I₂) is measured after the solid electrolyte is exposed in a dry room under a dew temperature of −60 °C for 24 hours, and a ratio (I₁:I₂) ranges from 1:0.5 to 1:0.8.

In one aspect of the present disclosure, 0.1 g of the solid electrolyte is placed in an acrylic box having a dimension of 130 mm×130 mm×250 mm, an emission amount of hydrogen sulfide (H₂S) is measured by using Gas Tiger 6000 equipment after the solid electrolyte is exposed to the atmosphere under a humidity condition of 65% for 20 minutes, and the emission amount of hydrogen sulfide (H₂S) is at most 310 ppm.

In one aspect of the present disclosure, a method for preparing a solid electrolyte includes preparing, pulverizing, and mixing a lithium source material, a phosphorus sulfide source material, a transition metal source material, and a halogen element source material (S1), and calcining a result from ‘S1’ at a temperature ranging from 300 °C to 600 °C. (S2), in which the transition metal source material is at least one metal compound of, or is selected from the group consisting of, transition metal elements which have an ion radius ranging from 0.4 Å to 1.0 Å and sulfur disassociation energy of at least 0.5 eV.

In one aspect of the present disclosure, the transition metal source material is at least one of, or is selected from the group consisting of, Co, Ni, Nb, and Mg.

In one aspect of the present disclosure provides, the transition metal source material is at least one divalent metal halide of Co, Ni, Nb, and Mg.

In one aspect of the present disclosure, ‘S2’ is performed for a time ranging from 4 hours to 8 hours.

In one aspect of the present disclosure, ‘S2’ is performed in a calcining furnace filled with an inert gas.

In one aspect of the present disclosure, an all solid state battery includes the solid electrolyte.

### BRIEF DESCRIPTION OF THE FIGURES

The above and other objects, features and advantages of the present disclosure will be more apparent from the following detailed description taken in conjunction with the accompanying drawings:

FIG. 1 is a view schematically illustrating a crystalline structure of a conventional sulfide-based solid electrolyte;

FIG. 2 is a view schematically illustrating a crystalline structure of a sulfide-based solid electrolyte according to an embodiment of the present disclosure;

FIG. 3 illustrates SEM-EDS images for a solid electrolyte according to Example 1 of the present disclosure;

FIG. 4 illustrates SEM-EDS images for a solid electrolyte according to Comparative example 1 of the present disclosure;

FIGS. 5 and 6 illustrate XRD spectra for solid electrolytes according to Examples 1 to 3 and Comparative examples 1 to 3 of the present disclosure;

FIG. 7 illustrates images obtained by photographing solid electrolytes according to Examples 1 to 3 and Comparative examples 1 to 3 of the present disclosure;

FIG. 8 illustrates graphs of impedances for solid electrolytes according to Examples 1 to 3 and Comparative examples 2 to 4 of the present disclosure;

FIG. 9 illustrates a graph of specific capacity as a function of a cycle number for pressed powder cells including solid electrolytes according to Example 1 and Comparative example 10 of the present disclosure;

FIG. 10 illustrates XRD spectra observed before and after exposing solid electrolytes of Examples 1 to 3 and Comparative example 1 of the present disclosure to a dry room;

FIG. 11 illustrates impedance graphs observed before and after exposing solid electrolytes of Examples 1 to 3 and Comparative example 1 of the present disclosure to a dry room;

FIG. 12 illustrates graphs illustrating an emission amount of hydrogen sulfide (H₂S) measured by exposing solid electrolytes according to Examples 1 and 3 and Comparative example 1 of the present disclosure to the atmosphere under a humidity of 65%; and

FIG. 13 illustrates a graph of specific capacity as a function of a cycle number for pressed powder cells including solid electrolytes according to Example 1 and Comparative example 1 of the present disclosure which was exposed in a dry room.

### DETAILED DESCRIPTION

Hereinafter, the present disclosure will be described in more detail for the understanding of the present disclosure.

For example, terms or words used in the present specification and the claims should not be interpreted as commonly-used dictionary meanings, but be interpreted as to be relevant to the technical scope of the present disclosure based on the fact that the inventor may properly define the concept of the terms to explain the present disclosure in best ways.

### ≤Solid Electrolyte>

The present disclosure provides a solid electrolyte.

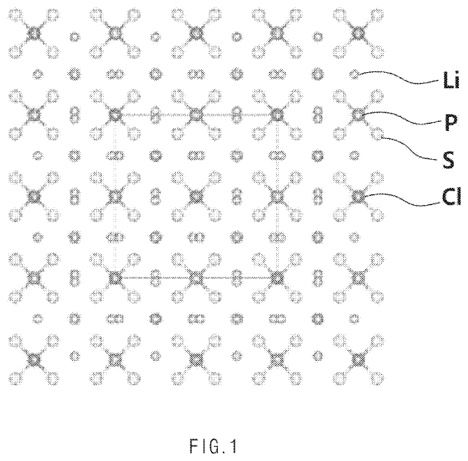

In general, the solid electrolyte is classified into an oxide-based solid electrolyte and a sulfide-based solid electrolyte, and the sulfide-based solid electrolyte exhibits higher lithium ion conductivity and stability in a wider voltage range, when compared to the oxide-based solid electrolyte. However, the typical sulfide-based solid electrolyte having the structure as illustrated in FIG. 1 may react with moisture in the atmosphere to emit potentially harmful hydrogen sulfide gas (H₂S), and may exhibit inferior oxidation stability at a higher voltage, thereby causing a side reaction with a cathode material during high-voltage operation.

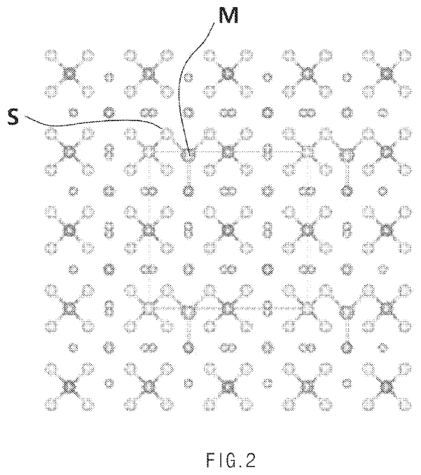

Accordingly, as illustrated in FIG. 2, solid electrolyte may exhibit improved air stability, improved stability at the higher voltage, and excellent ion conductivity. This may occur when a transition metal having a higher oxidation number higher than that of Li, having an ion radius ranging from 0.4 Å to 1.0 Å, and sulfur association energy of at least 0.5 eV is substituted at a Li-site of a sulfide-based argyrodite solid electrolyte.

The solid electrolyte according to an embodiment of the present disclosure may be a compound of at least Chemical Formula 1:

Li_{a-nb}M_{b}PS_{c}X_{d}, [Chemical Formula 1]
wherein in Chemical Formula 1,
‘M’ is at least one of, or is selected from the group consisting of, transition metal elements having an ion radius ranging from 0.4 Å to 1.0 Å and a sulfur association energy of at least 0.5 eV,
‘n’ is the oxidation number of ‘M’ and is greater than 1,
‘X’ is at least one halogen, and
6≤a≤8, 0<b<0.2, 3≤c≤6, 0<d≤3, and 5.2≤a−nb≤6.

According to an embodiment of the present disclosure, ‘a’ represents a possible molar ratio range of lithium (Li) in a sulfide-based solid electrolyte having an argyrodite-type crystal structure according to an embodiment of the present disclosure and the possible molar ratio may range from 6 to 8. In certain embodiments, ‘a’ may be at least 6.1, at least 6.2, at least 6.3, at least 6.4, or at least 6.5, and at most 7.8, at most 7.6, at most 7.4, at most 7.2, or at most 7. The argyrodite-type crystal structure according to an embodiment of the present disclosure may refer to a structure identical to that of the mineral Ag₅GeS₆.

According to an embodiment of the present disclosure, the ‘b’ represents a molar ratio of a transition metal (M) in the solid electrolyte according to an embodiment of the present disclosure and the molar ratio may be greater than 0 and less than 0.2. In certain embodiments, the ‘b’ may be at least 0.01, at least 0.02, at least 0.03, at least 0.04, or at least 0.05, and at most 0.18, at most 0.16, at most 0.14, at most 0.12, at most 0.10, at most 0.08, or at most 0.06. When the above-described ranges are satisfied, the reactivity of the solid electrolyte with moisture in air may be reduced, and the stability at the higher voltage and the ion conductivity may be improved.

According to an embodiment of the present disclosure, ‘M’ may be a transition metal having an oxidation number greater than that the Li, an ion radius ranging from 0.4 Å to 1.0 Å, and a sulfur association energy of at least 0.5 eV, and may be substituted at the Li-site of the solid electrolyte such that ‘M’ does not participate in an electrochemical reaction and forms strong bonding with a sulfur atom(S) in the crystal structure.

According to embodiments of the present disclosure, the ion radius of ‘M’ may be at least 0.5 Å, at least 0.55 Å, at least 0.6 Å, at least 0.65 Å, or at least 0.7 Å, and may also be at most 0.95 Å, at most 0.9 Å, at most 0.85 Å, or at most 0.8 Å. When the above-described ranges are satisfied, substitution within the Li-site may be smoothly achieved since the ion radius of ‘M’ becomes similar to an ion radius of Li⁺ (0.76 Å).

According to embodiments of the present disclosure, the sulfur association energy of ‘M’ may be at least 0.55 eV, at least 0.6 eV, at least 0.65 eV, at least 0.7 eV, at least 0.75 eV, at least 0.8 eV, or at least 0.85 eV. When the above-described ranges are satisfied, it may be evaluated that ‘M’ is strongly bonded to the sulfur atom(S) in the crystal structure without deteriorating other properties of the solid electrolyte. According to the present disclosure, the sulfur dissociation energy refers to the minimum energy required for a sulfur atom to be dissociated from the crystal structure.

In certain embodiments, the sulfur dissociation energy (E_{s-dissociation}) of ‘M’ may be calculated through following Equation 1 after obtaining energy (E_{perfect}) of an argyrodite crystal structure system doped based on the composition of Li_{6-n×0.25}M_{0.25}PS₅Cl, energy (E_{s_vacancy}) of a crystal structure system having an S vacancy, and then sulfur chemical potential (μₛ) calculated from an alpha-S structure, which is a stable structure of sulfur, through a density functional theory (DFT) methodology.

For example, the calculation of the density functional theory (DFT) methodology is performed by calculating the structure and the energy of an atom and an electron through a projector-augmented wave (PAW), by calculating an exchange-correlation function through a Perdew, Bruke, and Ernzerhof (PBE) model method based on a generalized gradient approximation (GGA), using a Vienna ab initio simulation package (VASP), by setting a Kinetic energy cutoff to 550 eV, and by using a 4×4×4 Monkhorst-Pack method.

E_{s-dissociation}=E_{s_vacancy}−E_{perfect}+μₛ [Equation 1]
in Equation 1,
E_{s-dissociation} is sulfur association energy,
E_{s_vacancy} is energy of a crystal structure system,
E_{perfect} refers to energy of the argyrodite crystal structure system doped, and Us is chemical potential of ‘S’.

According to an embodiment of the present disclosure, ‘M’ may be at least one of, or is selected from the group consisting of, Co, Ni, Nb, and Mg, (cobalt, nickel, niobium, and magnesium), and more specifically, in certain embodiments, may be Co or Ni. Each of these elements have an ion radius ranging from 0.4 Å to 1.0 Å and a sulfur association energy of at least 0.5 eV.

According to an embodiment of the present disclosure, the ‘n’ may be an oxidation number of ‘M1’ which is greater than the oxidation number (+1) of lithium (Li). In certain embodiments, ‘n’ may be at least 1.2, at least 1.4, at least 1.6, at least 1.8, or at least 2, and may also be at most 5, at most 4, at most 3, or at most 2.5 When the above-described ranges are satisfied, impurities may be reduced in the preparation process while maintaining the crystal structure of the solid electrolyte.

According to an embodiment of the present disclosure, the ‘c’ represents a molar ratio of the sulfur atom(S) in the solid electrolyte according to an embodiment of the present disclosure, and may range from 3 to 6. In certain embodiments, the ‘c’ may be at least 3.2, at least 3.4, at least 3.6, at least 3.8, or at least 4, and may also be at most 5.8, at most 5.6, at most 5.4, at most 5.2, or at most 5.

According to an embodiment of the present disclosure, the ‘d’ represents a possible molar ratio range of lithium (Li) of the solid electrolyte according to an embodiment of the present disclosure and the possible molar ratio may range from 0 to 3. In certain embodiments, ‘a’ may be at least 0.2, at least 0.4, at least 0.6, at least 0.8, or at least 1, and at most 3.8, at most 3.6, at most 3.4, at most 3.2, or at most 3.

According to an embodiment of the present disclosure, the ‘X’ may be one halogen. In certain embodiments, ‘X’ may be at least one of F, Cl, Br, and I (fluorine, chlorine, bromine, and iodine).

According to an embodiment of the present disclosure, when the ‘X’ represents a plurality of halogen elements, the ‘d’ may represent a total molar ratio of the ‘X’. For example, when the ‘X’ is Cl and Br, the ‘d’ may be the total molar ratio of Cl and Br. According to an embodiment of the present disclosure, the ‘a−nb’ represents a molar ratio of lithium (Li) in the solid electrolyte according to an embodiment of the present disclosure. In certain embodiments, the ‘a−nb’ and the possible molar ratio may range from 5.2 to 6. In certain embodiments, ‘a’ may be at least 5.22, at least 5.24, at least 5.26, at least 5.28, or at least 5.3, and at most 5.9, at most 5.8, at most 5.7, at most 5.6, or at most 5.5. When the above-described range is satisfied, the argyrodite crystal structure may be maintained such that reactivity of the solid electrolyte with moisture in the air is reduced, and stability and ion conductivity may be improved at a higher voltage.

According to an embodiment of the present disclosure, the solid electrolyte may include a compound of Chemical Formula 2:

Li_{a-nb□nb-b}M_{b}PS_{c}X_{d} [Chemical Formula 2]
wherein, in Chemical Formula 2,
‘M’ is at least one of, or is selected from the group consisting of, Co, Ni, Nb, and Mg,
‘□’ is a vacancy at a Li-site,
‘n’ is the oxidation number of ‘M’ and is greater than 1,
‘X’ is at least one halogen, and
6≤a≤8, 0<b<0.2, 3≤c≤6, 0<d≤3, and 5.2≤a−nb≤6.

The descriptions for ‘a’, ‘b’, ‘c’, ‘d’, ‘n’, and ‘a−nb’ as included in Chemical Formula 2 are identical to the descriptions for ‘a’, ‘b’, ‘c’, ‘d’, ‘n’, and ‘a−nb’ in Chemical Formula 1. Accordingly, the details thereof will be omitted.

According to an embodiment of the present disclosure, the ‘□’, represents the vacancy at the Li-site, and the transition metal having the oxidation number higher than of Li at the Li-site. Accordingly, the ‘□’ may be produced in an ion crystal structure of the solid electrolyte by the Schottky defect or the Frenkel defect, which is a point defect, or may form a diffusion path of the lithium ion (Li+).

According to an embodiment of the present disclosure, the ‘nb−b’, which represents a molar ratio of the vacancy at the Li-site in the solid electrolyte, may range from greater than 0 to 2.8. In certain embodiments, the ‘nb−b’ may be at least 0.1, at least 0.2, at least 0.3, at least 0.4, or at least 0.5, and may also be at most 2.6, at most 2.4, at most 2.2, or at most 2. In embodiments falling within the above range, the argyrodite crystal structure may be maintained such that reactivity of the solid electrolyte with moisture in the air is reduced, and stability and ion conductivity may be improved at a higher voltage.

According to an embodiment of the present disclosure, the solid electrolyte may include a compound expressed by following Chemical Formula 3.

Li_{5.5-nb□nb-b}M_{b}PS_{4.5}Cl_{c1}Br_{c2} [Chemical Formula 3]
in Chemical Formula 3,
‘M’ is at least one of, or is selected from the group consisting of, Co, Ni, Nb, and Mg,
‘□’ is a vacancy at a Li-site,
‘n’ is the oxidation number of ‘M’, and
0.05<b<0.2, 5.2<5.5-nb<6, 0<c1<1, and 0<c2<1 0<nb−b<2.8.

As the solid electrolyte according to an embodiment of the present disclosure includes a compound having the above-described composition, the solid electrolyte may have crystalline structure belonging to the argyrodite crystal structure or the space group F-43m.

In the solid electrolyte according to an embodiment of the present disclosure, an a-axis lattice constant calculated through the Rietveld analysis may be at most 9.9 Å. In certain embodiments, the a-axis lattice constant may be at most 9.895 Å, at most 9.89 Å, at most 9.885 Å, at most 9.88 Å, at most 9.875 Å, at most 9.87 Å, or at most 9.865 Å, and may also be at least 9.0 Å, at least 9.1 Å, at least 9.2 Å, at least 9.3 Å, at least 9.4 Å, or at least 9.5 Å. The above-described range may be satisfied as the transition metal having an oxidation number greater than that of the lithium (Li) in the Li-site of the solid electrolyte and forming the strong bond with the S and the halogen element in the crystal structure is substituted.

When the solid electrolyte according to an embodiment of the present disclosure is measured using the Hunter Lab colorimeter, an L-color value may range from 8 to 46. In certain embodiments, the L-color value may be at least 9, at least 10, at least 11, at least 12, at least 13 or at least 14, and may also be at most 44, at most 42, at most 40, at most 38, at most 36 or at most 34. The above-described range may be satisfied as the transition metal having an oxidation number greater than that of the lithium (Li) in the Li-site of the solid electrolyte and forming the strong bond with the S and the halogen element in the crystal structure is substituted.

The solid electrolyte according to an embodiment of the present disclosure may not have a peak at a position in which 20 is 27±0.5°, 36±0.5°, or 40±1° and may also not have a peak at a position in which 20 is 35±0.5° or 46±0.5°, in an X-Ray Diffraction (XRD) pattern measured using CuKα. This is because the transition metal having an oxidation number greater than that of the lithium (Li) at the Li-site of the solid electrolyte and forming the strong bond with the S and the halogen element in the crystal structure is substituted.

As the solid electrolyte according to an embodiment of the present disclosure has the above-described structure and the above-described composition, the solid electrolyte may satisfy the excellent ion conductivity, the excellent higher-voltage driving stability, the lower resistance value, and the lower moisture reactivity.

The ion conductivity of the solid electrolyte according to an embodiment of the present disclosure may be at least 7 mS/cm. In certain embodiments, the ion conductivity may be at least 7.5 mS/cm, at least 8 mS/cm, at least 8.5 mS/cm, at least 9 mS/cm, or at least 9.5 mS/cm.

The resistance of the solid electrolyte according to an embodiment of the present disclosure, which is measured through Electrochemical Impedance Spectroscopy (EIS), may be at most 7 (2. In certain embodiments, the resistance of the solid electrolyte according to an embodiment may be at most 6.5Ω, at most 6Ω, at most 5.5Ω, or at most 5Ω.

For the solid electrolyte according to an embodiment of the present disclosure, the ratio (P₁:P₂) of the peak intensity (P₂) observed at a position, in which 25.5±0.5°, in the XRD pattern measured using CuKα, after the solid electrolyte was exposed in the dry room under the dew temperature of −60 °C for 24 hours to the peak intensity (P₁) observed at the position, in which 25.5±0.5°, in an XRD pattern measured by using CuKα, may be range from 1:0.7 to 1:0.95. In certain embodiments, the ratio (P₁:P₂) may be at least 1:0.71, at least 1:0.72, at least 1:0.73, at least 1:0.74, or at least 1:0.75, and also, at most 1:0.9, at most 1:0.88, at most 1:0.86, at most 1:0.84, at most 1:0.82, or at most 1:0.8.

For the solid electrolyte according to an embodiment of the present disclosure, the ratio (I₁:I₂) of the ion conductivity (I₂) measured after the solid electrolyte was exposed in the dry room under the dew temperature of −60 °C for 24 hours to the ion conductivity (I₁) measured for the solid electrolyte may be range from 1:0.5 to 1:0.8. In certain embodiments, the ratio (I₁:I₂) may be at least 1:0.52, at least 1:0.54, at least 1:0.56, at least 1:0.58, or at least 1:0.6, and also, at most 1:0.78, at most 1:0.76, at most 1:0.74, at most 1:0.72, or at most 1:0.7.

For the solid electrolyte according to an embodiment of the present disclosure, 0.1 g of the solid electrolyte is placed in an acrylic box having the dimension of 130 mm×130 mm×250 mm and an emission amount of hydrogen sulfide (H₂S) is measured by using Gas Tiger 6000 equipment after exposed to the atmosphere under the humidity condition of 65% for 20 minutes. For example, the emission amount of hydrogen sulfide (H₂S) may be at most 310 ppm. In certain embodiments, the emission amount of hydrogen sulfide (H₂S) may be at most 305 ppm, at most 300 ppm, at most 295 ppm, at most 290 ppm, at most 285 ppm, at most 280 ppm, at most 275 ppm, or at most 270 ppm.

### <Method for Preparing Solid Electrolyte>

A method for preparing a solid electrolyte according to an embodiment of the present disclosure may at least include the steps for preparing, pulverizing, and mixing the lithium source material, the phosphorus sulfide source material, the transition metal source material, and the halogen element source material (S1); and calcining a mixture from ‘S1’ at a temperature ranging from 400 °C to 500 °C (S2), in which the transition metal source material is at least one metal compound of, or is selected from the group consisting of, transition metal elements which have an ion radius ranging from 0.4 Å to 1.0 Å and the sulfur disassociation energy of at least 0.5 eV.

Hereinafter, the method for preparing the solid electrolyte according to an embodiment of the present disclosure will be specifically described step by step.

### ‘S1’

The method for preparing the solid electrolyte according to an embodiment of the present disclosure may include the step for preparing, pulverizing, and mixing the lithium source material, the phosphorus sulfide source material, the transition metal source material, and the halogen element source material (S1).

According to an embodiment of the present disclosure, the lithium source material may be, for example, lithium sulfide (Li₂S), but the present disclosure is not limited thereto.

According to an embodiment of the present disclosure, the phosphorus sulfide source material may be, for example, phosphorus pentasulfide (P₂S₅), but the present disclosure is not limited thereto.

According to an embodiment of the present disclosure, the transition metal source material may include at least one metal compound of, or is selected from the group consisting of, Co, Ni, Nb, and Mg. In certain embodiments, the transition metal source material may be at least one divalent metal compound of Co, Ni, Nb, and Mg, and, more particularly may be at least divalent metal halides of Co, Ni, Nb, and Mg. According to an embodiment of the present disclosure, the transition metal source material may be a metal compound of Co or Ni. In certain embodiments, the transition metal source material may be a divalent metal compound of Co or Ni, and more specifically, in certain embodiments, may be a divalent metal halide of Co or Ni.

According to an embodiment of the present disclosure, the halogen element source material may be a metal halide, and specifically, in certain embodiments, may be a lithium halide.

According to an embodiment of the present disclosure, in ‘S1’, the respective source materials may be weighed in appropriate amounts corresponding to compositions of Chemical Formulae 1 to 3 and may be ground and mixed.

According to an embodiment of the present disclosure, the pulverizing operation in ‘S1’ may be performed through a high energy ball milling scheme. In certain embodiments, the pulverizing operation in ‘S1’ may be performed under the condition of a rotational speed ranging from 300 rpm to 700 rpm for a time ranging from eight hours to 15 hours.

### ‘S2’

The method for preparing the solid electrolyte according to an embodiment of the present disclosure may include the step for calcining the mixture from ‘S1’ at the temperature range from 400 °C to 500 °C (S2).

According to an embodiment of the present disclosure, ‘S2’ may be performed at temperatures ranging from 300 °C to 600 °C. In certain embodiments, ‘S2’ may be performed at the temperature range of at least 320 °C, at least 340 °C, at least 360 °C, at least 380 °C, or at least 400 °C, and may also be at most 580 °C, at most 560 °C, at most 540 °C, at most 520 °C, or at most 500 °C.

According to an embodiment of the present disclosure, ‘S2’ may be performed for a time ranging from 4 hours to 8 hours, and specifically, in certain embodiments, may be performed for a time of at least 4.5 hours, at least 5 hours, or at least 5.5 hours, and at most 7.5 hours, at most 7 hours, or at most 6.5 hours.

According to an embodiment of the present disclosure, ‘S2’ may be performed in a calcining furnace comprising or filled with an inert gas. In certain embodiments, the inert gas may be Ar (argon) gas.

The method for preparing the solid electrolyte according to an embodiment of the present disclosure may further include a step S3 of controlling a particle size by grinding a result of the step S2, and the step S3 may be performed through High Energy Ball Milling.

### All Solid State Battery

The present disclosure provides an all solid state battery including a solid electrolyte in accordance with the aspects and embodiments described herein.

According to an embodiment of the present disclosure, the all solid state battery may have a stack structure of an anode current collector, an intermediate layer, a solid electrolyte layer, a cathode active material layer, and a cathode current collector.

According to an embodiment of the present disclosure, the anode current collector may be a base provided in the form of a plate having electrical conductivity. In certain embodiments, the anode current collector may have the form of a sheet, a thin film, or a foil.

According to an embodiment of the present disclosure, the anode current collector may a material which does not react with lithium. In detail, the anode current collector may include at least any one of, or is selected from, Ni, Cu, stainless steel (SUS), and any combination thereof.

According to an embodiment of the present disclosure, the intermediate layer may include an anode active material, the solid electrolyte, and a binder.

According to an embodiment of the present disclosure, the anode active material is not specifically limited thereto. For example, the anode active material may include a carbon active material and a metal active material.

According to an embodiment of the present disclosure, the carbon active material may be graphite, such as mesocarbon microbeads (MCMB) and highly oriented graphite (HOPG), or amorphous carbon such as hard carbon, and soft carbon.

According to an embodiment of the present disclosure, the metal active material may be In, Al, Si, and Sn, and an alloy containing at least one element of In, Al, Si, and Sn.

According to an embodiment of the present disclosure, the solid electrolyte may include a sulfide-based solid electrolyte. In certain embodiments, the solid electrolyte may include at least one of, or is selected from the group consisting of, Li₇₋ₓPS₆₋ₓAₓ (0≤x≤1; ‘A’ is at least one of, or is selected from the group consisting of, Cl, Br and I), Li₁₀GeP₂S₁₂, Li₃PS₄, Li₂P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (‘m’ and ‘n’ is positive number; ‘Z’ is one of Ge, Zn, and Ga), Li₂S—GeS₂, Li₂S—SiS₂—Li₃PO₄, Li₂S—SiS₂-LiₓMO_{y} (′x′ and ‘y’ are positive numbers; M is one among P, Si, Ge, B, Al, Ga, and In), and a combination thereof, or at least one of, or is selected from the group consisting of, compounds expressed by Chemical Formulae 1, 2, and 3.

According to an embodiment of the present disclosure, the conductive material is a component to form an electron transferring path within the electrode. The conductive material may be a sp2 carbon material, such as carbon black, conducting graphite, ethylene black, and carbon nanotube, or graphene.

According to an embodiment of the present disclosure, the binder may include butadiene rubber (BR), nitrile butadiene rubber (NBR), hydrogenated nitrile butadiene rubber (HNBR), polyvinylidene difluoride (PVDF), polytetrafluoroethylene (PTFE), or carboxymethylcellulose (CMC).

According to an embodiment of the present disclosure, the intermediate layer may include the lithium alloy-based metal including lithium and an alloy.

According to an embodiment of the present disclosure, the lithium alloy-based metal may be at least one of, or is selected from the group consisting of, Sn, Cd, Ag, Au, Pt, Pd, Mg, Zn, and combinations thereof, and specifically, in certain embodiments, may be at least one of, or is selected from the group consisting of, Mg, Zn, Ag, Au, and combinations thereof, and more specifically, in certain embodiments, may be Mg.

According to an embodiment of the present disclosure, when the intermediate layer includes the lithium alloy-based metal, the lithium alloy-based metal may be manufactured through a scheme such as a sputtering scheme or a chemical vapor deposition scheme.

According to an embodiment of the present disclosure, the solid electrolyte layer transfers a lithium ion between the cathode and the anode.

According to an embodiment of the present disclosure, the solid electrolyte included in the solid electrolyte layer may be at least one of, or is selected from the group consisting of, compounds expressed by Chemical Formulae 1, 2, and 3.

According to an embodiment of the present disclosure, a cathode active material layer may include a cathode active material, the solid electrolyte, the conductive material, and the binder.

According to an embodiment of the present disclosure, the cathode active material is not specifically limited thereto. For example, the cathode electrode active material may include an oxide active material, and a sulfide active material.

According to an embodiment of the present disclosure, the oxide active material may include a rock salt type active material, such as LiCoO₂, LiMnO₂, LiNiO₂, LiVO₂, Li₁₊ₓNi_{1/3}Co_{1/3}Mn_{1/3}O₂, a spinel type active material, such as LiMn₂O₄, Li(Ni_{0.5}Mn_{1.5})O₄, a reverse spinel type active material, such as LLiNiVO₄, LiCoVO₄, an olivine-type active material, such as LiFePO₄, LiMnPO₄, LiCoPO₄, or LiNiPO₄, a silicon-containing active material, such as Li₂FeSiO₄, or Li₂MnSiO₄, a rock salt type active material, such as LiNi_{0.8}Co_{(0.2-x)} AlₓO₂ (0<x<0.2), which is obtained by substituting a portion of transition metal with a heterogeneous metal, a spinel-type active material, such as Li₁₊ₓMn_{2-x-y}M_{y}O₄ (′M′ is at least one of Al, Mg, Co, Fe, Ni, and Zn; 0<x+y<2), which is obtained by substituting a portion of the transition metal with a heterogeneous metal, or lithium titanate such as Li₄Ti₅O₁.

According to an embodiment of the present disclosure, the sulfide active material may be copper Chevrel, iron sulfide, cobalt sulfide, or nickel sulfide.

According to an embodiment of the present disclosure, the solid electrolyte may include a sulfide-based solid electrolyte. In certain embodiments, the solid electrolyte may include at least one of, or is selected from the group consisting of, Li₇₋ₓPS₆₋ₓAₓ (0≤x≤1; ‘A’ is at least one of, or is selected from the group consisting of, Cl, Br and I), Li₁₀GeP₂S₁₂, Li₃PS₄, Li₂P₃S₁₁, Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂SSiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (′m′ and ‘n’ is positive number; ‘Z’ is one of Ge, Zn, and Ga), Li₂S—GeS₂, Li₂S—SiS₂—Li₃PO₄, Li_{z}S—SiS₂-LiₓMO_{y} (′x′ and ‘y’ are positive numbers; M is one among P, Si, Ge, B, Al, Ga, and In), and a combination thereof, or at least one of, or is selected from the group consisting of, compounds expressed by Chemical Formulae 1, 2, and 3.

According to an embodiment of the present disclosure, the conductive material and the binder have been described above, and the details thereof will be omitted below.

According to an embodiment of the present disclosure, the cathode current collector may be a base provided in the form of a plate having an electrical conductivity. In detail, the cathode current collector may have the form of a sheet or a thin film.

According to an embodiment of the present disclosure, the cathode current collector may include at least one of, or is selected from the group consisting of, indium, copper, magnesium, aluminum, stainless steel, iron, and any combination thereof.

Hereinafter, an embodiment of the present disclosure will be described in detail such that those skilled in the art may easily reproduce the embodiment of the present disclosure. However, the present disclosure may be implemented in various forms, and is limited to embodiments described herein.

### Example 1—Li_{5.4}Co_{0.05}PS_{4.5}Cl_{0.75}Br_{0.75}

Lithium sulfide (Li₂S) serving as the lithium source material, phosphorus pentasulfide (P₂S₅) serving as the phosphorus sulfide source material, cobalt (II) chloride (CoCl₂) and cobalt (II) bromide (CoBr₂) serving the transition metal source materials, and lithium chloride (LiCl), and lithium bromide (LiBr) serving as the halogen element source materials were prepared to be a mixture of 2 g in total weight. Each of the above source material was weighed to provide a composition of Li_{5.4}Co_{0.05}PS_{4.5}Cl_{0.75}Br_{0.75} and was put in Si₃N₄ jar. A high energy ball milling operation was performed with respect to the mixture at 500 rpm for 12 hours.

The resulting mixture from the high energy ball milling process was heated to 450 °C at a rate of 2.5 °C/min in a sealed quartz tube filled with Ar gas, and was calcined at 450 °C for six hours to prepare a solid electrolyte.

### Example 2—Li_{5.3}Co_{0.1}PS_{4.5}Cl_{0.75}Br_{0.75}

A solid electrolyte according to Example 2 was prepared in the same method as that of Example 1 except that each of the above source materials was weighed in amounts to provide a composition of Li_{5.3}Co_{0.1}PS_{4.5}Cl_{0.75}Br_{0.75}.

### Example 3—Li_{5.4}Ni_{0.05}PS_{4.5}Cl_{0.75}Br_{0.75}

A solid electrolyte according to Example 3 was prepared in the same method as that of Example 1 except that lithium sulfide (Li₂S) serving as the lithium source material, phosphorus pentasulfide (P₂S₅) serving as the phosphorus sulfide source material, nickel (II) chloride (NiCl₂) and nickel (II) bromide (NiBr₂) serving as the transition metal source materials, and lithium chloride (LiCl), and lithium bromide (LiBr) serving as the halogen element source materials were prepared to be 2 g in a total weight. Each of the above source material was weighed to provide a composition of Li_{5.4}Co_{0.05}PS_{4.5}Cl_{0.75}Br_{0.75}.

### Comparative Example 1—Li_{5.5}PS₅Cl_{0.75}Br_{0.75}

A solid electrolyte according to Comparative example 1 was prepared in the same method as that of Example 1 except that lithium sulfide (Li₂S) serving as the lithium source material, phosphorus pentasulfide (P₂S₅) serving as the phosphorus sulfide source material, and lithium chloride (LiCl) and lithium bromide (LiBr) serving as the halogen element source material were prepared to be 2 g in a total weight. Each of the above source material was weighed to provide a composition of Li_{5.4}Ni_{0.05}PS_{4.5}Cl_{0.75}Br_{0.75}.

### Comparative Example 2—Li_{5.1}Co_{0.2}PS_{4.5}Cl_{0.75}Br_{0.75}

A solid electrolyte according to Comparative example 2 was prepared in the same method as that of Example 1 except that each of the above source materials was weighed to provide a composition of Li_{5.1}Co_{0.2}PS_{4.5}Cl_{0.75}Br_{0.75}.

### Comparative Example 3—Li_{4.9}Co_{0.3}PS_{4.5}Cl_{0.75}Br_{0.75}

A solid electrolyte according to Comparative example 2 was prepared in the same method as that of Example 1 except that each of the above source materials was weighed to provide a composition of Li_{4.9}Co_{0.3}PS_{4.5}Cl_{0.75}Br_{0.75}.

### Comparative Example 4—Li_{5.35}Al_{0.05}PS_{4.5}Cl_{0.75}Br_{0.75}

Lithium sulfide (Li₂S) serving as a lithium source material, phosphorus pentasulfide (P₂S₅) serving as a phosphorus sulfide source material, cobalt (II) chloride (CoCl₂) and cobalt (II) bromide (CoBr₂) serving as transition metal source materials, and lithium chloride (LiCl), and lithium bromide (LiBr) serving as a halogen element source material were prepared to be 2 g in a total weight. Each of the above source materials was weighed to provide a composition of Li_{5.35}Co_{0.05}PS_{4.5}Cl_{0.75}Br_{0.75} and was put in Si₃N₄ jar. A high energy ball milling operation was performed with respect to the resulting mixture at 500 rpm for 12 hours.

The resulting mixture from the high energy ball milling process was heated to 450 °C at a rate of 2.5 °C/min in a sealed quartz tube filled with Ar gas, and was calcined at 450 °C for six hours to prepare the solid electrolyte.

### Experimental Example 1: Analysis of Structure of Solid Electrolyte and Evaluation of Characteristics

### 1) SEM-EDS Analysis

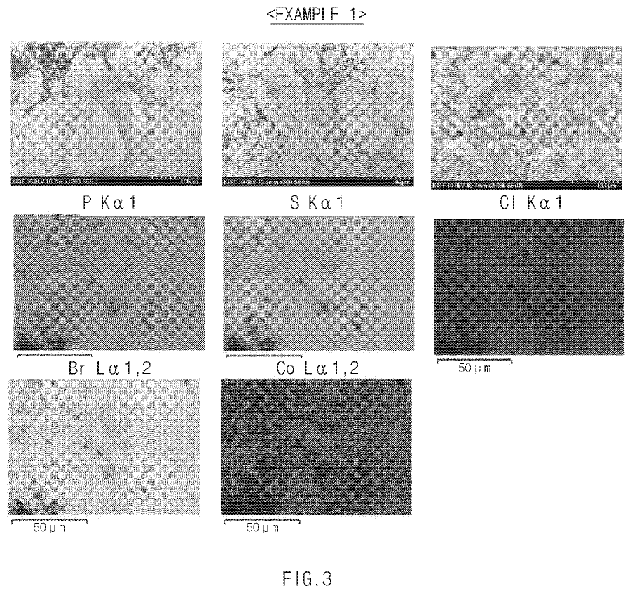

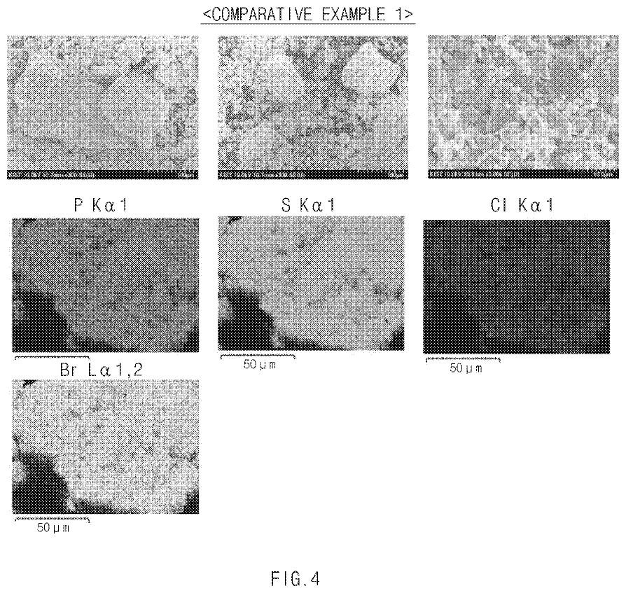

An SEMS image and EDS mapping for each of the solid electrolytes prepared according to Example 1 and Comparative example 1 are illustrated in FIGS. 3 and 4. Apreo 2S (by Thermofisher) was used as SEM equipment, and ChemiSEM equipment (by Thermofisher) was used as SEM-EDS equipment.

Referring to FIG. 3 and FIG. 4, the data indicate that elements in the solid electrolytes of Example 1 and Comparative Example 1 were uniformly distributed.

### 2) XRD Analysis

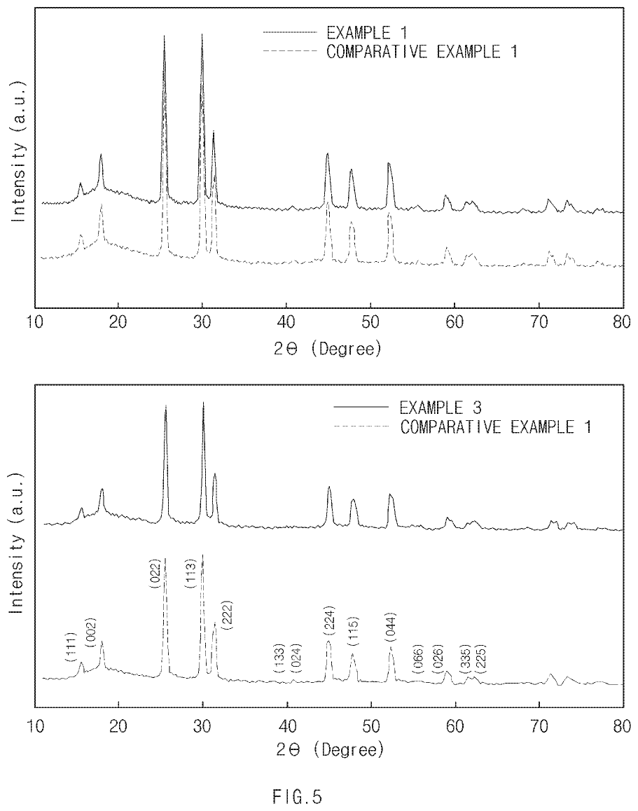

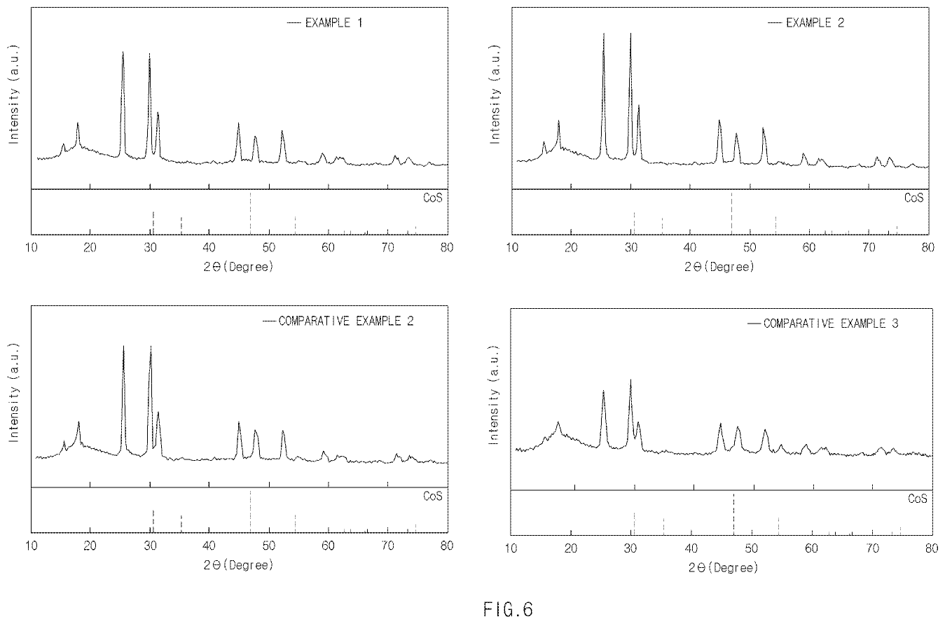

The solid electrolytes according to Examples 1 to 3 and Comparative examples 1 to 3 were analyzed by using Miniflex (by Rigaku) under the following conditions: the voltage was 40 kV, the current was 15 mA, CuKα, 2θ (Bragg angle)=10° to 80°, and scan speed=2°/60 sec to obtain XRD spectra, and the XRD spectra are illustrated in FIGS. 5 and 6.

Referring to FIGS. 5 and 6, it may be conformed that even when preferable transition metal elements are substituted at the Li-site as in Examples 1 to 3, the argyrodite structure is maintained well as in Comparative Example 1.

In addition, the data indicate that the argyrodite structure was smoothly maintained in Examples 1 and 2 including Co substituted in a preferable content, and a peak was observed due to impurities (CoS) in Comparative examples 2 and 3 including Co substituted in an excessive content. In particular, the data indicate that the intensity of the peak representing the argyrodite was reduced in Comparative example 2. This is because, as the Co is substituted in a content greater than necessary, the content of the Li was decreased and many vacancies were formed, which makes it difficult to maintain the argyrodite structure.

### 3) Analysis of Lattice Constant and Space Group

The XRD data according to the Examples and the Comparative examples measured as described above were calculated through an XRD Rietveld refinement method, thereby obtaining space groups according to Examples 1 to 3 and Comparative example 1, and the space groups were shown in Table 1.

Referring to Table 1, the data indicate that even when the preferable transition metal was substituted at the Li-site, the crystal structure of F-43m is maintained.

TABLE 1

| | Space group |
|---|---|
| Example 1 | F-43 m |
| Example 2 | F-43 m |
| Example 3 | F-43 m |
| Comparative | F-43 m |
| example 1 | |

In addition, the a-axis lattice constant (9.86 Å) according to Example 1 and the a-axis lattice constant (9.93 Å) according to Comparative example 1 were obtained by calculating XRD data according to Examples and the Comparative examples through the XRD Rietveld refinement method, and compared to each other. For example, the data indicate that the lattice constant of the solid electrolyte according to Example 1 in which the preferable transition element M was substituted at the Li-site was smaller than the lattice constant according to Comparative example 1. In addition, the result may be interpreted as being made because the structure was shrunken by the strong bond between M-S, M-Cl, or M-Br.

### 4) Measurement of Apparent Color

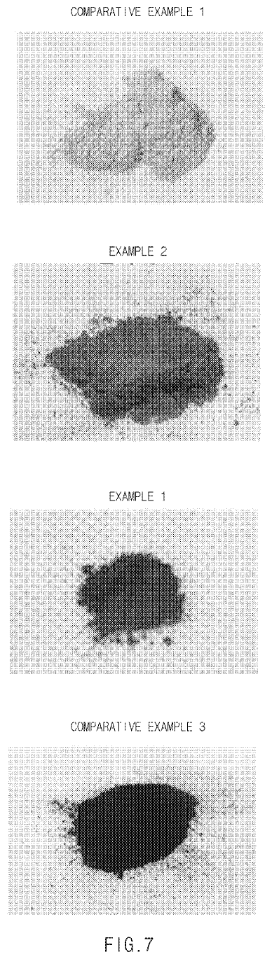

L, a, and b values for the solid electrolytes according to Examples 1 and 2 and Comparative examples 1 and 3 were measured using a Hunter Lab color difference meter and shown in Table 2. In addition, images obtained by photographing the solid electrolytes according to Examples 1 and 2 and Comparative Examples 2 and 10 are illustrated in FIG. 7.

TABLE 2

| | Apparent color | | |
|---|---|---|---|
| | L | a | b |
| Example 1 | 14.92 | −1.15 | 0.34 |
| Example 2 | 31.57 | −2.25 | 6.57 |
| Comparative | 61.49 | −0.53 | 11.65 |
| Example 1 | | | |
| Comparative | 1.74 | −0.24 | −4.98 |
| Example 3 | | | |

Referring to Table 2 and FIG. 7, the data indicate that as the amount of the substituted Co was increased, the color of the solid electrolyte became gradually darker, and the L value of the color difference meter was decreased.

### 4) EIS Measurement

For the solid electrolytes prepared according to Examples 1 to 3 and Comparative examples 2 to 4, impedances were measured through Electrochemical Impedance Spectroscopy (EIS) under the condition of the frequency ranging from 1 M to 10 mHz, and the amplitude of 10 mV, and are shown in Table 8.

Subsequently, based on the measured impedance, the resistance values for the solid electrolytes prepared according to Examples 1 to 3 and Comparative examples 2 to 4 were obtained, and the ion conductivity was calculated using following Equation 2 and are shown in Table 3.

$$Ion conductivity ( α ) = \frac{1}{{R}_{b}} \times \frac{t}{A} \qquad [ Equation 2 ]$$

in Equation 2,
R_{b} is a resistance,
‘t’ is the thickness of test sample of solid electrolyte, and
‘A’ is a cross-sectional area (1.3273 cm²) of test sample of solid electrolyte.

TABLE 3

| | Ion conductivity | Resistance |
|---|---|---|
| | (mS/cm) | (Ω) |
| Example 1 | 10.1 | 4.7 |
| Example 2 | 8.5 | 5.62 |
| Example 3 | 7.27 | 6.8 |
| Comparative | 4.53 | 9.9 |
| Example 2 | | |
| Comparative | — | — |
| Example 3 | | |
| Comparative | 7.8 | 9.7 |
| example 4 | | |

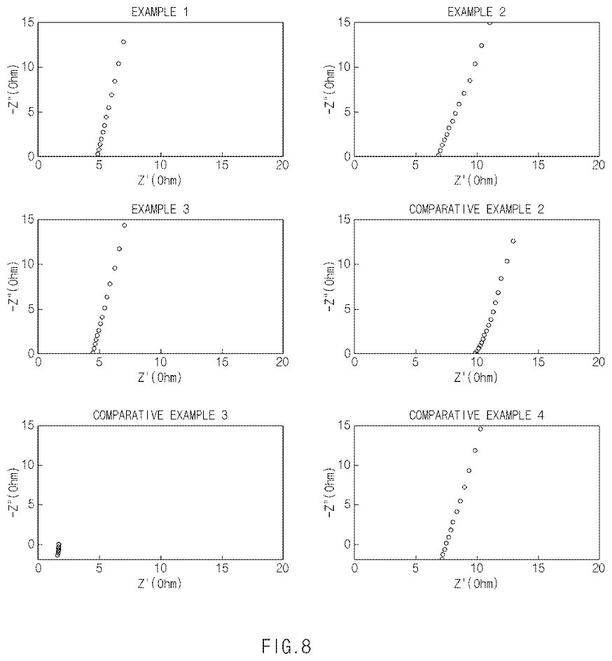

Referring to Table 3 and FIG. 8, the data indicate that the Examples in which a preferable content of a preferable transition metal M was substituted at the Li-site, exhibited excellent ion conductivity and low resistance values.

Meanwhile, the data indicate that Comparative examples 2 and 3 in which an excessive content of Co was substituted at the Li-site, exhibited lower ion conductivity and higher resistance values. The result may be interpreted as being made because as the Co content was increased, the content of the Li to be diffused was decreased.

The data indicate that Comparative example 4 including Al (the sulfur association energy calculated by the following Equation 1 is 0.46 eV) substituted at the Li-site exhibited the significantly increased resistance value.

### Experimental Example 2: Evaluation of Battery Characteristics

### 1) Manufacturing of Pressed Powder Cell

The pressed powder cells including the solid electrolytes according to Example 1 and Comparative example 1 applied to the electrolyte layer were manufactured as follows.

First, the cathode active material (LiNbO₃ coated LiNi_{0.8}Co_{0.1}Mn_{0.1}O₂), the solid electrolyte (Li₆PS₅Cl_{0.5}Br_{0.5}), the binder (nitrile butadiene rubber dissolved at 2.5 wt % in a normal butyl butyrate solution), and Super C65 were introduced into a Pulverisette 23 Mini Mill mixer at a weight ratio of 70:29:1:1, and mixed under the condition of 20 rpm for one hour thereby preparing a slurry. The prepared slurry was applied on the cathode current collector including Al, and having a thickness of 10 μm at a loading amount of 20 mg/cm², and dried in a vacuum oven at a temperature of 100 °C for 12 hours, thereby preparing a 12@ cathode.

150 mg of solid electrolytes according to Example 1 and Comparative example 1 was pressed at a pressure of 45 MPa to form the electrolyte layer, and a Li foil having a thickness of 0.2 mm was pressed on the formed electrolyte layer at a pressure of 45 MPa, thereby preparing the pressed powder cell.

### 2) Evaluation of C-Rate Characteristics

Each of the pressed powder cells employing the solid electrolytes prepared according to Example 1 and Comparative example 1 was charged to 4.25 V at 0.1 C (1 C=185 mAh/g) in the CC-CV mode at 25 °C, and then discharged to 2.5 V at 0.1 C (1 C=185 mAh/g) in a CC mode at 25 °C during Precycle, and was charged to 4.25 V at 0.1 C (1 C=185 mAh/g) in the CC-CV mode at 25 °C, and then discharged to 2.5 V at 0.1 C (1 C=185 mAh/g) in a CC mode at 25 °C during the first cycle. Each of the pressed powder cells was charged to 4.25 V at 0.2 C (1 C=185 mAh/g) in the CC-CV mode at 25 °C, and then discharged to 2.5 V at 0.2 C (1 C=185 mAh/g) in the CC mode at 25 °C during the second cycle, and was charged to 4.25 V at 0.33 C (1 C=185 mAh/g) in the CC-CV mode at 25 °C, and then discharged to 2.5 V at 0.33 C (1 C=185 mAh/g) in the CC mode at 25 °C during the third cycle. Each of the pressed powder cells was charged to 4.25 V at 0.5 C (1 C=185 mAh/g) in the CC-CV mode at 25 °C, and then discharged to 2.5 V at 0.5 C (1 C=185 mAh/g) in the CC mode at 25 °C during the fourth cycle, and was charged to 4.25 V at 1 C (1 C=185 mAh/g) in the CC-CV mode at 25 °C, and then discharged to 2.5 V at 1 C (1 C=185 mAh/g) in the CC mode at 25 °C during the fifth cycle. Each of the pressed powder cells was charged to 4.25 V at 2 C (1 C=185 mAh/g) in the CC-CV mode at 25 °C, and then discharged to 2.5 V at 2 C (1 C=185 mAh/g) in the CC mode at 25 °C during the sixth cycle. A charge capacity (mAh/g), a discharge capacity (mAh/g), and coulombic efficiency (%) measured during each cycle are shown in Table 4.

TABLE 4

| | | | Comparative |
|---|---|---|---|
| | | Example 1 | example 1 |
| pre-cycle | Charge capacity | 208.2 | 214.2 |
| (0.1 C) | Discharge capacity | 191.1 | 189.5 |
| | Coulombic efficiency | 91.8 | 88.5 |
| 1^{st} cycle | Charge capacity | 192.6 | 195.7 |
| (0.1 C) | Discharge capacity | 186.9 | 186.6 |
| | Coulombic efficiency | 97.0 | 95.4 |
| 2^{nd} cycle | Charge capacity | 189.4 | 189.5 |
| (0.2 C) | Discharge capacity | 178.5 | 178.8 |
| | Coulombic efficiency | 94.2 | 94.4 |
| 3^{rd} cycle | Charge capacity | 180.6 | 180.1 |
| (0.33 C) | Discharge capacity | 171.4 | 170.9 |
| | Coulombic efficiency | 94.9 | 94.9 |
| 4^{th} cycle | Charge capacity | 172.6 | 171.6 |
| (0.5 C) | Discharge capacity | 165.2 | 163.3 |
| | Coulombic efficiency | 95.7 | 95.1 |
| 5^{th} cycle | Charge capacity | 166.1 | 163.9 |
| (1 C) | Discharge capacity | 152.2 | 149.5 |
| | Coulombic efficiency | 92.9 | 91.2 |
| 6^{th} cycle | Charge capacity | 154.9 | 150.1 |
| (2 C) | Discharge capacity | 142.6 | 133.3 |
| | Coulombic efficiency | 92.1 | 88.8 |

Referring to Table 4, the data indicate that Example 1 including Co substituted at the Li-site exhibited a more excellent initial discharge capacity and a more excellent initial coulombic efficiency, when compared to Comparative example 1. In addition, the data indicate that Example 1 including Co substituted at the Li-site exhibited a more excellent discharge capacity and a more excellent coulombic efficiency at the higher current density of 2 C, when compared to Comparative example 1. The result may be interpreted as being made because the substitution of Co at the Li-site increased the structural stability of the solid electrolyte, suppressed the side reactions with the cathode and the anode, and reduced the interfacial resistance.

### 3) Evaluation of Lifespan Characteristics

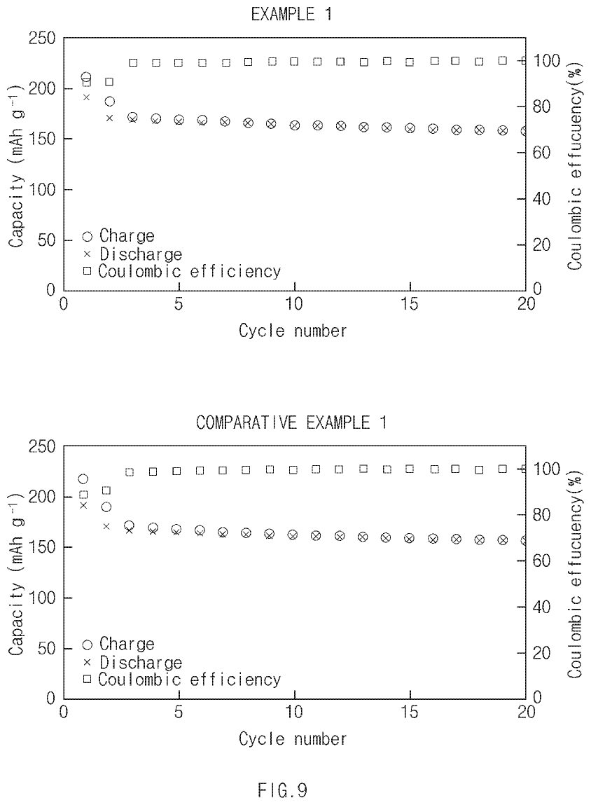

Each of the pressed powder cells employing the solid electrolytes prepared according to Example 1 and Comparative example 1 was charged to 4.25 V at 0.1 C (1 C=185 mAh/g) in the CC-CV mode at 25 °C, and then discharged to 2.5 V at 0.1 C (1 C=185 mAh/g) in the CC mode at 25 °C during Precycle, and was charged to 4.25 V at 0.5 C (1 C=185 mAh/g) in the CC-CV mode and then discharged to 2.5 V at 0.5 C (1 C=185 mAh/g) in the CC mode at 25 °C, during the cycles from the first cycle to the twentieth cycle to measure a specific capacity and coulombic efficiency per cycle, and the measured specific capacity and coulombic efficiency per cycle are shown in FIG. 9.

TABLE 5

| | First | 20-th | |
|---|---|---|---|
| | cycle | cycle | Capacity |
| | discharge | discharge | retention |
| | capacity | capacity | rate |
| Example 1 | 170.7 mAh/g | 157.0 mAh/g | 92.0% |
| Comparative | 169.2 mAh/g | 154.8 mAh/g | 91.5% |
| example 1 | | | |

Referring to Table 4 and FIG. 9, the data indicate that the pressed powder cell according to Example 1 showed the discharge capacity of 157.0 mAh/g and the capacity retention of 92.0%, and the pressed powder cell according to Comparative example 10 showed the discharge capacity of 154.8 mAh/g and the capacity retention of 91.5%, at the twenties cycle. Accordingly, the data indicate that the substitution of Co at the Li-site improved the lifespan characteristic. The result may be interpreted as being made because the substitution of Co at the Li-site increased the structural stability of the solid electrolyte.

### Experimental Example 3: Evaluation of Environmental Stability

### 1) XRD Measurement

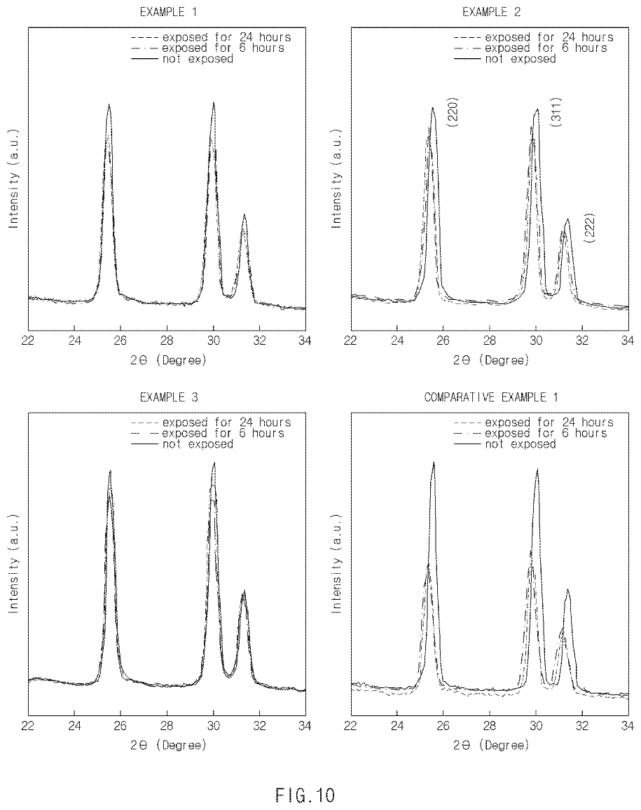

1 g of each of the solid electrolytes prepared according to Examples 1 to 3 and Comparative example 1 was thinly spread on wax paper and placed on a Petri dish. Then, the solid electrolytes, which were (i) not exposed, (ii) exposed for 6 hours, and (iii) exposed for 24 hours in a dry room having a dew point temperature of −60 °C, were measured using the Miniflex (by Rigaku) under the conditions of a voltage of 40 kV, a current of 15 mA, CuKα, a 2θ (Bragg angle) range of 22° to 34°, and a scan speed of 2°/60 sec, and the XRD spectra for the measurement results were obtained and are shown in FIG. 10.

Referring to FIG. 10, the data indicate that the peak intensity was hardly reduced or shifted even if the solid electrolytes were exposed in the dry room for a long time when a preferable transition metal (M) was substituted at the Li-site. Accordingly, the solid electrolyte in which the preferable transition metal (M) was substituted at the LI-site exhibited excellent environmental stability.

### 2) ElS Measurement

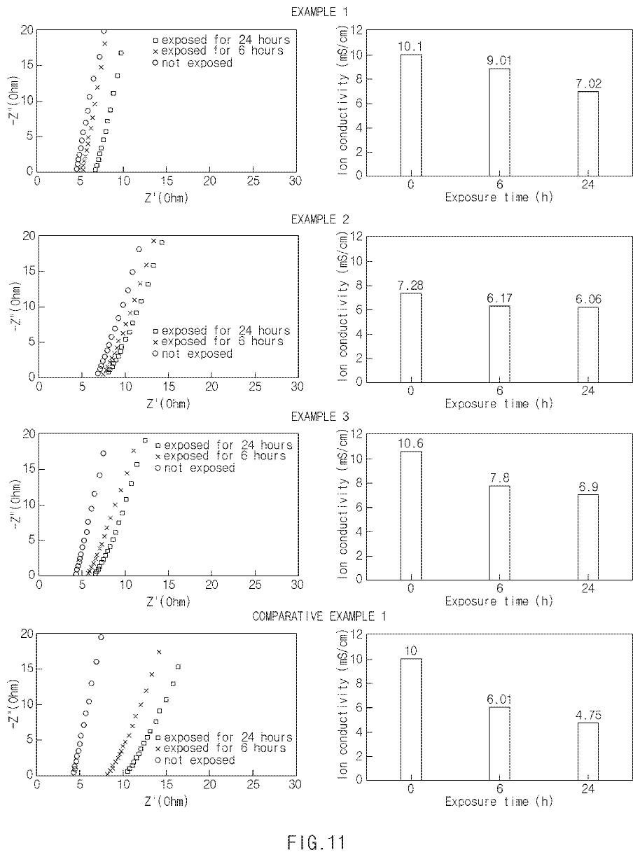

1 g of each of the solid electrolytes prepared according to Examples 1 to 3 and Comparative example 1 was thinly spread on wax paper and placed on a Petri dish. Then, the impedances and the ion conductivities of the solid electrolytes, which were (i) not exposed, (ii) exposed for 6 hours, and (iii) exposed for 24 hours in a dry room having a dew point temperature of −60 °C, were measured through EIS under the conditions of the frequency ranging from 1 M to 10 mHz, and the amplitude of 10 mV (the method for calculating the ion conductivity have been described in Experimental example 2 above), and are shown in FIG. 11.

Referring to FIG. 11, the data indicate that the ion conductivity retention of the solid electrolyte according to Example 1 (ion conductivity of solid electrolyte exposed for 24 hours/ion conductivity of solid electrolyte not exposed×100) was 70%, and the ion conductivity retention of the solid electrolyte according to Example 2 (ion conductivity of solid electrolyte exposed for 24 hours/ion conductivity of solid electrolyte not exposed×100) was 83.2%. In addition, the data indicate that the ion conductivity retention of the solid electrolyte according to Example 3 (ion conductivity of solid electrolyte exposed for 24 hours/ion conductivity of solid electrolyte not exposed×100) was 65.1%, and the ion conductivity retention of the solid electrolyte according to Comparative example 1 (ion conductivity of solid electrolyte exposed for 24 hours/ion conductivity of solid electrolyte not exposed×100) was 47%. The result may be interpreted as being made because the transition metal atom (M) substituted at the Li-site formed the strong bond with the sulfur atom(S) present in the crystal structure of the solid electrolyte, thereby suppressing the reaction between sulfur(S) and moisture (H₂O), and oxygen (O₂).

### 3) Measurement of Emission Amount of H₂S

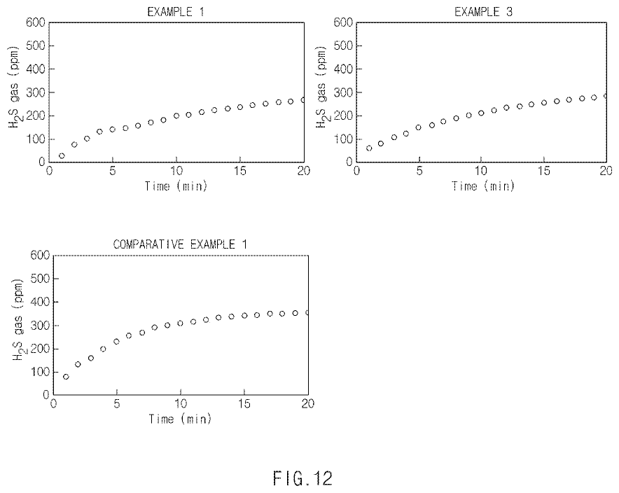

0.1 g of each of the solid electrolytes according to Example 1 and 3, and Comparative example 1 was placed in an acrylic box having the dimension of 130 mm×130 mm×250 mm, and exposed to the atmosphere under the humidity condition of 65%, and an emission amount of hydrogen sulfide (H₂S) was measured for 20 minutes by using Gas Tiger 6000 equipment, as illustrated in FIG. 12.

Referring to FIG. 12, the data indicate that the emission amount of hydrogen sulfide (H₂S) measured after the solid electrolyte according to Embodiment 1 was exposed to the atmosphere for 20 minutes under the humidity condition of 65% was 267.3 ppm, the emission amount of hydrogen sulfide (H₂S) measured after the solid electrolyte according to Embodiment 3 was exposed to the atmosphere for 20 minutes under the humidity condition of 65% was 284.6 ppm, and the emission amount of hydrogen sulfide (H₂S) measured after the solid electrolyte according to Comparative example 1 exposed to the atmosphere for 20 minutes under the humidity condition of 65% was 360.9 ppm.

Accordingly, the data indicate that the solid electrolyte according to Example 1 showed that the emission amount of hydrogen sulfide (H₂S) was reduced by about 28%, when compared to the solid electrolyte according to Comparative example 1, and the data indicate that the solid electrolyte according to Example 3 showed that the emission amount of hydrogen sulfide (H₂S) was reduced by about 21%, when compared to the solid electrolyte according to Comparative example 1. The result may be interpreted as being made because the transition metal atom (M) substituted at the Li-site formed the strong bond with the sulfur atom(S) present in the crystal structure of the solid electrolyte, thereby suppressing the reaction between sulfur(S) and moisture (H₂O), and oxygen (O₂).

### 4) Evaluation of Lifespan Characteristics of Pressed Powder Cell

The pressed powder cells employing the solid electrolytes according to Example 1 and Comparative Example 1, which were exposed for 6 hours in a dry room at a dew point temperature of −60 °C, and were applied to the electrolyte layer, were manufactured as described in Experimental example 3.

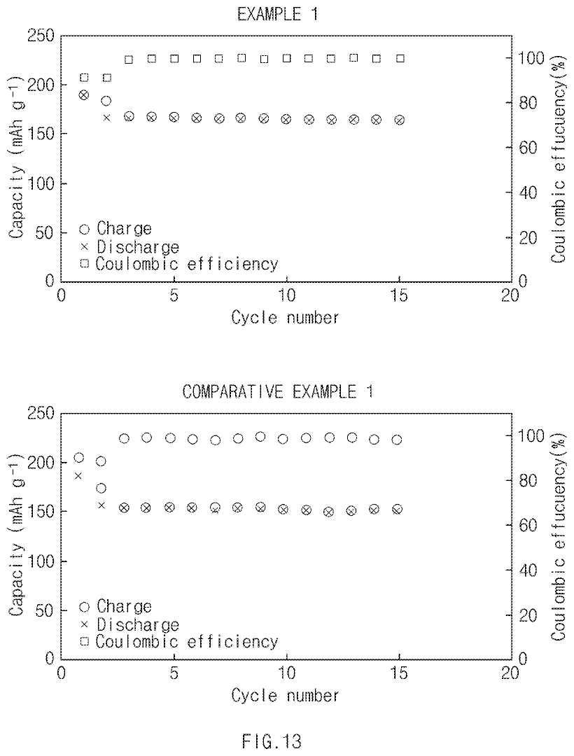

Thereafter, each pressed powder cell was charged to 4.25 V at 0.1 C (1 C=185 mAh/g) in the CC-CV mode at 25 °C and discharged to 2.5 V at 0.1 C (1 C=185 mAh/g) in the CC mode at 25 °C during the Precycle, and was charged to 4.25 V at 0.5 C (1 C=185 mAh/g) in the CC-CV mode at 25 °C and discharged to 2.5 V at 0.5 C (1 C=185 mAh/g) in the CC mode at 25 °C during the cycle ranging from the 1^{st} cycle to 15^{th} cycle, thereby measuring the specific capacity and the coulombic efficiency per cycle, and the measurement results are shown in FIG. 13.

Referring to FIG. 13, the data indicate that the pressed powder cell according to Example 1 showed the discharge capacity of 163.1 mAh/g and the capacity retention of 98.1%, and the pressed powder cell according to Comparative example 1 showed the discharge capacity of 154.3 mAh/g and the capacity retention of 91.5%, at the 15th cycle. Accordingly, the data indicate that the discharge capacity and the capacity retention rate were more excellent in Example 1 employing Co substituted at the Li-site, when compared to Comparative example 1 employing Co not substituted in the exposure in the dry room. The result may be interpreted as being made because the substitution of Co at the Li-site increased the structure stability of the solid electrolyte.

As described above, the solid electrolyte according to an embodiment of the present disclosure exhibits the lower reactivity with moisture in the air, and exhibits the excellent stability and excellent ion conductivity at the higher voltage.

In the method for preparing the solid electrolyte according to an embodiment of the present disclosure, the solid electrolyte may be prepared with the lower reactivity with moisture in the air, and the excellent stability and excellent ion conductivity at the higher voltage.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A solid electrolyte including a compound of Chemical Formula 1:
Li_{a-nb}M_{b}PS_{c}X_{d},
wherein
‘M’ is at least one transition metal having an ion radius ranging from 0.4 Å to 1.0 Å and having sulfur association energy of at least 0.5 eV,
‘n’ is an oxidation number of the ‘M’ and greater than 1,
‘X’ is at least halogen, and
6≤a≤8, 0<b<0.2, 3≤c<6, 0<d≤3, and 5.2≤a−nb≤6.

2. The solid electrolyte of claim 1, including a compound of Chemical Formula 2:
Li_{a-nb□nb-b}M_{b}PS_{c}X_{d},
wherein
‘M’ is at least one of Co, Ni, Nb, and Mg,
‘□’ is a vacancy at a Li-site,
‘n’ is an oxidation number of the ‘M’ and is greater than 1,
‘X’ is at least one halogen, and
6≤a≤8, 0<b<0.2, 3≤c≤6, 0<d≤3, 5.2≤a−nb≤6, and 0<nb−b≤2.8.

3. The solid electrolyte of claim 1, including a compound of Chemical Formula 3:
Li_{5.5-nb□nb-b}M_{b}PS_{4.5}Cl_{c1}Br_{c2}
wherein
‘M’ is at least one of Co, Ni, Nb, and Mg,
‘□’ is a vacancy at a Li-site,
‘n’ is an oxidation number of ‘M’ and greater than 1, and
0.05≤b<0.2, 5.235.5−nb≤6, 0<c1≤1, and 0<c2≤1 0<nb−b≤2.8.

4. The solid electrolyte of claim 1, wherein the solid electrolyte has a crystal structure of a space group F-43m.

5. The solid electrolyte of claim 1, wherein the solid electrolyte has an argyrodite crystal structure.

6. The solid electrolyte of claim 1, wherein the solid electrolyte has an a-axis lattice constant that is at most 9.9 Å when calculated using a Rietveld analysis method.

7. The solid electrolyte of claim 1, wherein the solid electrolyte has an L-color value that ranges from 8 to 46 as measured using a Hunter Lab colorimeter.

8. The solid electrolyte of claim 1, wherein the solid electrolyte is characterized by an X-Ray Diffraction (XRD) pattern lacking a peak at a position in which 2θ is 27±0.5°, 36±0.5°, or 40±1°, as measured using CuKα.

9. The solid electrolyte of claim 1, wherein the solid electrolyte is characterized by an XRD pattern lacking a peak at a position in which 2θ is 35±0.5°, or 46±0.5°, as measured using CuKα.

10. The solid electrolyte of claim 1, wherein the solid electrolyte has a resistance, which is calculated through Electrochemical Impedance Spectroscopy (EIS), that is at most 7 Ω.

11. The solid electrolyte of claim 1, characterized by an ion conductivity of at least 7 mS/cm.

12. The solid electrolyte of claim 1, characterized by an XRD pattern having:
a peak intensity (P₁) observed at a position, in which 2θ=25.5±0.5°, as measured using CuKα, and
a peak intensity (P₂) observed at a position, in which 2θ=25.5±0.5°, as measured using CuKα, after the solid electrolyte is exposed in a dry room under a dew temperature of −60 °C for 24 hours, and
wherein a ratio (P₁:P₂) between the peak intensity (P₁) and the peak intensity (P₂) ranges from 1:0.7 to 1:0.95.

13. The solid electrolyte of claim 1, characterized by:
an ion conductivity (I₁), and
an ion conductivity (I₂) after the solid electrolyte is exposed in a dry room under a dew temperature of −60 °C for 24 hours, and
wherein a ratio (I₁:I₂) ranges from 1:0.5 to 1:0.8.

14. The solid electrolyte of claim 1, characterized by an emission amount of hydrogen sulfide (H₂S) of at most 310 ppm as measured by using Gas Tiger 6000 equipment after 0.1 g of the solid electrolyte is placed in an acrylic box having dimensions of 130 mm×130 mm×250 mm and the 0.1 g of the solid electrolyte is exposed to the atmosphere under a humidity condition of 65% for 20 minutes.

15. A method for preparing a solid electrolyte, the method comprising the steps of:
preparing a mixture comprising a lithium source material, a phosphorus sulfide source material, a transition metal source material, and a halogen element source material; and
calcining the mixture at a temperature ranging from 300 °C to 600 °C, wherein the transition metal source material is at least one transition metal having an ion radius ranging from 0.4 Å to 1.0 Å and sulfur disassociation energy of at least 0.5 eV.

16. The method of claim 15, wherein the transition metal source material is at least one of Co, Ni, Nb, and Mg.

17. The method of claim 16, wherein the transition metal source material is at least one divalent metal halide of Co, Ni, Nb, and Mg.

18. The method of claim 15, wherein the calcining step is performed for a time ranging from four hours to eight hours.

19. The method of claim 15, wherein the calcining step is performed in a calcining furnace comprising an inert gas.

20. An all solid state battery including a solid electrolyte according to claim 1.
